(19) United States
(12) Patent Application Publication
(10) Pub. No.: US 2024/0389614 A1
(43) Pub. Date: Nov. 28, 2024

(54) THERMO-REVERSIBLE PLANT PROTEIN GELS

(71) Applicant: THE GOVERNORS OF THE UNIVERSITY OF ALBERTA, Edmonton (CA)

(72) Inventor: Lingyun CHEN, Edmonton (CA)

(21) Appl. No.: 18/693,449

(22) PCT Filed: Sep. 29, 2022
(86) PCT No.: PCT/CA2022/051449

§ 371 Date: Mar. 19, 2024

Related U.S. Application Data
(60) Provisional application No. 63/250,016, filed on Sep. 29, 2021.

(51) Int. Cl. A23J 1/14; A23D 9/00

(52) U.S. Cl. CPC A23J 1/14; A23D 9/00

(57) ABSTRACT

Disclosed are thermo-reversible protein gels formed from (i) pulse plant proteins extracted by a salted in-salted out precipitation method, (ii) vicilin and/or convicilin, or (iii) a pulse plant protein isolate having an isoelectric point of greater than 5.0; methods of forming such gels, and food or beverages including such gels.

### FIELD OF THE INVENTION

The present invention relates to thermo-reversible gels comprising plant protein.

### BACKGROUND

Thermo-reversible gels are gels that can be melted and reformed in response to temperature, which are crosslinked by physical interactions, for example, through helix formation in gelatin and carrageenan; crystallization in polyethylene; or complex formation between polymers such as polyvinyl alcohol and borate. In food applications, thermo-reversible gels made from gelatin, carrageenan and gellan gum have been extensively used in the production of pudding, desserts, dairy products like yogurt, beverages and spreads owing to their “melting in the mouth” sensation or “mouth feel”.

Based on its thermo-reversible characteristics and excellent viscoelastic properties, gelatin-based gels have been widely applied for drug and natural health products encapsulations where the gelatin dissolves in hot water, and then forms a gel upon cooling to encapsulate bioactive ingredients. Gelatin gels are also transparent, which is considered as an additional advantage for gelatin for its food and pharmaceutical applications such as protective coating material, stabilizer/gelling agent in dessert, and particularly important for retinal tissue where transparency is desired.

Other animal-based proteins have also shown ability to form thermo-reversible gels, for example, muscle protein from cod formed thermo-reversible gelation at pH 9 and 11 and Krill protein gel was also found to display a thermo-reversible behavior. Egg white lysozyme forms a thermo-reversible gel with the addition of dithiothreitol (DTT) that consisted of semi-flexible beta-sheet rich fibres to promote cell spreading and proliferation for potential tissue engineering scaffold applications.

Despite the advantages and potential applications brought by thermo-reversible protein-based gels, they are made from animal proteins. The replacement of animal protein with ingredients of plant origin may be desirable in many instances.

### SUMMARY

In general terms, this disclosure provides a thermo-reversible protein gel comprising or consisting essentially of pulse plant proteins, and preferably without any animal protein. The proteins may preferably comprise or consist essentially of vicilin or convicilin, or are may be extracted using a salt precipitation method, such as with ammonium sulfate. In preferred embodiments, the pulse plant is pea.

The thermo-reversibility of the gels disclosed herein is stable upon repeated heating and cooling process from 80° C. to 4° C., as confirmed by dynamic rheological measurement.

In some embodiments, the extracted pulse plant proteins have a higher isoelectric point, preferably greater than about pH 5.5, and more preferably about pH 6.0.

In some embodiments, the protein concentration of the gelling composition is greater than about 5% and below about 17% (w:v), and preferably between about 10 to about 15% (w:v).

In some embodiments, the protein gelling pH is in the range of about pH 2.4 to about pH 4.2. An acidic pH, preferably less than about 4.0, such as 3.8, favors the formation of transparent gels with fine-stranded network as observed by scanning electron microscopy (SEM), whereas with a pH at or above about 4.0, such as 4.2, favors the formation of opaque gels with a gel network having particulate aggregates. Gel thermo-reversibility is retained in either case.

In some embodiments, the gels disclosed herein have the characteristics of being transparent and thermo-reversible, and having mechanical properties to be suitable to replace gelatin in food applications such as fruit, beverage and fermented food products, particularly those which present mild acidic pH environments.

Thus, in one aspect, the present disclosure provides a thermo-reversible protein gel comprising proteins which comprise or consist essentially of:
a. pulse plant proteins extracted by a salted in-salted out precipitation method;
b. vicilin and/or convicilin; or
c. a pulse plant protein isolate having an isoelectric point of greater than 5.0, preferably greater than about 5.5, and more preferably about 5.9.

In some embodiments, the thermo-reversible gel comprises at least one or a combination of the following features. The pulse plant may be pea. The proteins may have been extracted with a salt precipitation method such as an ammonium sulfate precipitation method. The gel may be repeatedly thermo-reversible at temperatures between about 4° C. and about 80° C. The gel may be thermo-reversible in a pH range of between about 2.4 to about 4.2, with a protein concentration between about 10% (w:v) to about 15%. In particular, the gel may be thermo-reversible in a pH range from pH 2.4 to 4.2 for a 10% (w:v) protein gel; from pH 2.4 to 3.8 for 13% (w:v) protein gel; or from pH 2.4 to 3.2 for 15% (w:v) protein gel. The gel may have a salt concentration of less than about 2%, or in the range of 0.1% to about 1.0%. The gel may further comprise an oil of less than about 70% (v:v), or between about 20% and about 60%. The oil is preferably a vegetable oil such as canola oil.

In another aspect, the present disclosure provides a method of forming a thermo-reversible gel comprising extracting a pulse plant protein isolate using an salted in-salted out precipitation method, forming an aqueous gelling composition of the proteins having a protein concentration greater than about 5% (w:v) and less than about 17% (w:v), at a pH of greater than about 2.4 and less than about 4.2.

In some embodiments, the method may comprise at least one or any combination of the following features. The salt precipitation method may be an ammonium sulfate precipitation method. The pH of the gelling composition may be in the range of pH 2.4 to 4.2 for a 10% (w:v) protein gel; from pH 2.4 to 3.8 for 13% (w:v) protein gel; or from pH 2.4 to 3.2 for 15% (w:v) protein gel. The gelling composition may have a salt concentration of less than about 2%, or in the range of 0.1% to about 1.0%. The gelling composition may comprise an oil in less than about 70% (v:v), or between about 20% and about 60%. The oil is preferably a vegetable oil such as canola oil.

In another aspect, the present disclosure provides a food or beverage comprising a thermo-reversible gel as disclosed or claimed herein.

### BRIEF DESCRIPTION OF THE DRAWINGS

The attached drawings form part of the specification and are included to demonstrate certain embodiments or various aspects of the invention. In some instances, embodiments of the invention can be understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

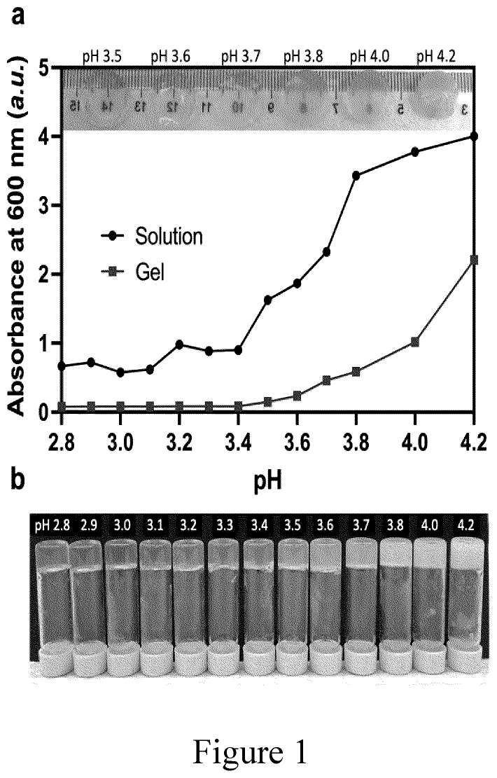

(a) FIG. 1. Effect of pH value on (a) absorbance of solution of pea protein isolate extracted from ammonium sulfate precipitation method (ASE-PPI) (before heating) and gel (after heating) with 10% protein concentration at 600 nm; (b) appearance of formed gels.

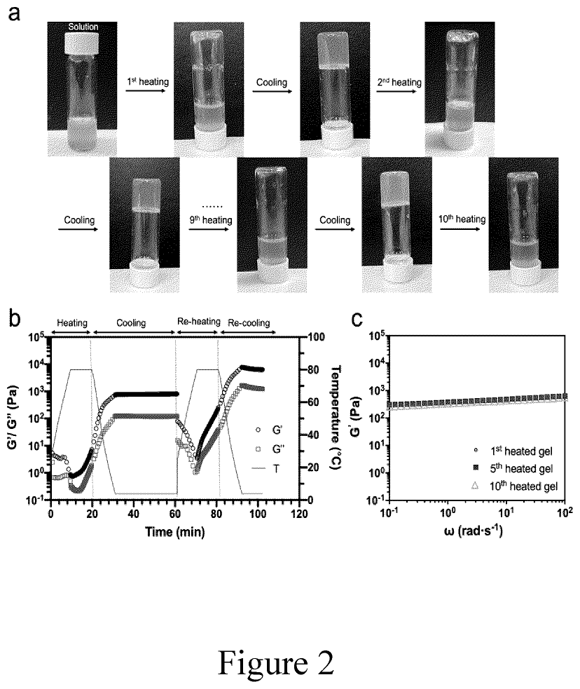

(b) FIG. 2. (a) Photographs of thermo-reversible gels through 10 heating and cooling cycles starting with 10% ASE-PPI solution at pH 3.4; Rheological properties of ASE-PPI solution and gels (10 wt %) with multiple heating and cooling cycles: (b) thermo-reversible rheological response of ASE-PPI solution within two heating and cooling cycles; (c) storage modulus (G′) of ASE-PPI gels heated and cooled for 1 time, 5 times and 10 times, respectively as functions of frequency.

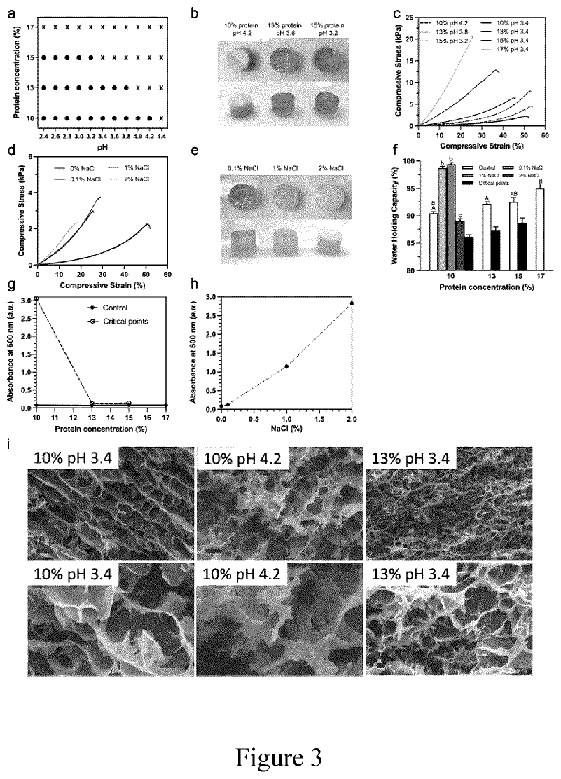

(c) FIG. 3: Characterizations were performed on the ASE-PPI gels (10-17 wt % PPI) prepared at 80° C. with different pH value and salt concentration and stored at 4° C. overnight: (a) Phase diagram of gels prepared at different protein concentration and pH values (x) non-thermo-reversible, (•) thermo-reversible. (b) Image of gels of different protein concentration prepared at critical pH values. (c) Compressive strength and strain curve at break of gels formed at different protein concentration and critical points. (d) Effect of salt concentration (0-2 wt % NaCl) on compressive strength and strain at break of gels prepared at fixed protein concentration (10%) and pH value (pH 3.4). (e) Image of gels formed at different salt concentration (10% protein, pH 3.4). (f) Water holding capacity of gels formed at different conditions. Critical points: gels of 10-15% protein prepared at critical pH values. (g, h) Absorbance of gels formed at different conditions at 600 nm. Control: gels of 10-17% protein prepared at pH 3.4. (i) SEM images of pea protein gels prepared at different pH and protein concentration.

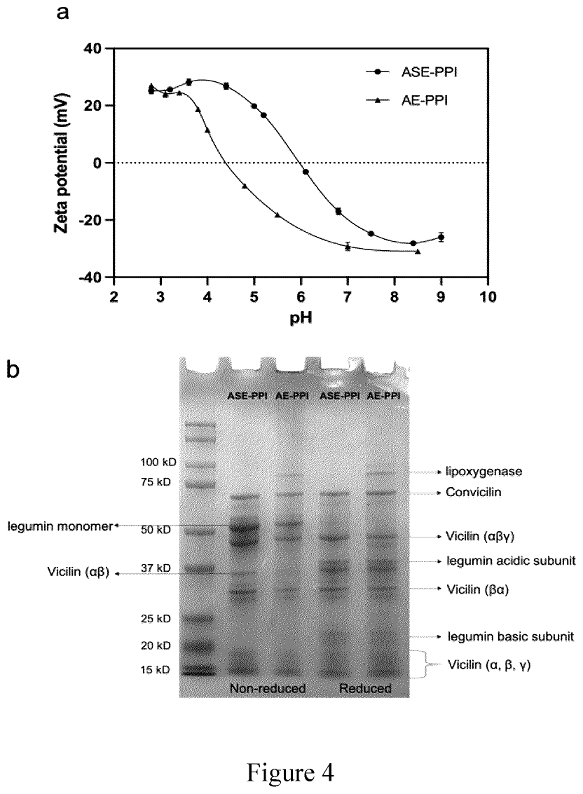

(d) FIG. 4: (a) Zeta potential vs pH curves showing the isoelectric point of ASE-PPI and pea protein isolate extracted by conventional alkaline extraction and isoelectric point precipitation method (AE-PPI). (b) Electrophoretic patterns of ASE-PPI and AE-PPI at 0.5 wt % protein concentration under reducing and non-reducing conditions.

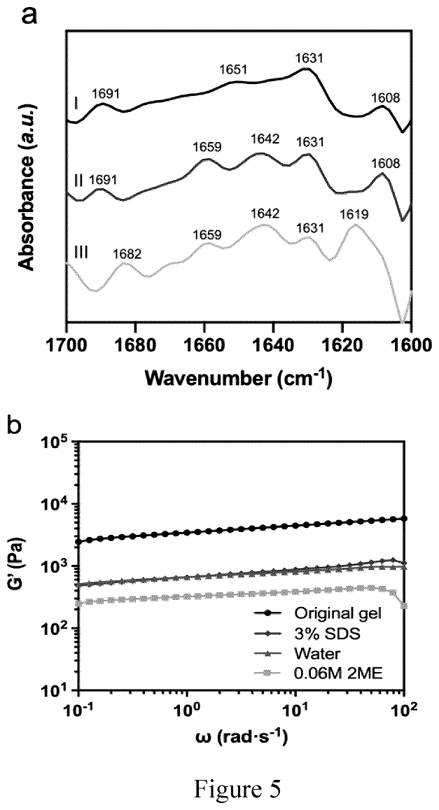

(e) FIG. 5: (a) Deconvoluted FTIR spectra of ASE-PPI solutions (5 wt %) in the amide I region, which were prepared to simulate the formation of gel: (I) Native ASE-PPI solution; (II) ASE-PPI solution at pH 3.4; (III) ASE-PPI solution heated at pH 3.4 at 80° C. for 10 min and cooled at 4° C. overnight. (b) Frequency dependence of storage modulus (G′) of pea protein gels (10 wt % protein concentration) formed at pH 3.4 before and after soaking in various dissociation reagents for 2 h.

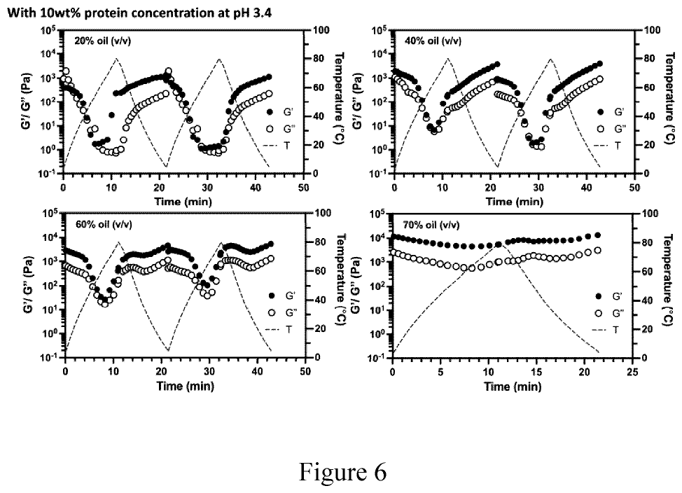

(f) FIG. 6: Thermo-reversibility of gels with various canola oil fractions, from 20% to 70%. The gels were prepared at 10% pea protein concentration at pH 3.4.

### DETAILED DESCRIPTION

Provided herein is a thermo-reversible gel prepared from pulse plant protein, preferably without any animal protein. “Thermo-reversible” or “thermally reversible” means that the gel can be melted and reformed simply by heating and cooling the gel. Without restriction to a theory, hydrogen bonds are believed to be dominant in forming the gel network structure during the cooling process while hydrophobic interactions and disulfide bonds are not significantly involved. Thus, the thermo-reversible gels are physically crosslinked through hydrogen bonds that can be disrupted at high temperature and can be reformed during cooling process, in like manner to gelatin gels.

As used herein, a “pulse” plant is a leguminous crop that is harvested for the dry seed. Beans, lentils and peas are the most commonly known and consumed types of pulses. Globulins and albumins are two major protein groups in pulse protein, accounting for 70-80% and 10-20%, respectively. Legumin (11S), vicilin (7S) and convicilin are three main proteins of the globulins. Legumin is a hexameric protein (˜360 kDa) with six subunits linked through disulfide bonds while both vicilin and convicilin are a trimeric protein of ˜150 kDa and ˜210 kDa respectively, with no disulfide bonds involved. Vicilin and convicilin are major components involved in thermo-reversible gel formation as disclosed herein.

In some embodiments, thermo-reversible gels are prepared from a pulse protein isolate which has been extracted by a “salting in and salting out” effect, such as by ammonium sulfate precipitation. Preferably, no significant pH change or heat is used to extract the protein isolate. Salt precipitation is a method where protein solubility is increased upon the addition of salt (e.g. <0.15 M) and where protein solubility then decreases as the salt concentration goes up, leading to protein precipitation (Wingfield, 2001). This method has been used to isolate protein with high purity and minimum denaturation (Zhang et al., 2017) because no heating or severe pH change has been involved in the protein extraction.

Thermally induced gels may be prepared from pea protein concentrates isolated by alkaline extraction followed by acidic precipitation (AE-PPI). Although such gels have good mechanical properties (compressive strength of 18.48±2.79 kPa with good water holding capacity over 95%), they are not thermo-reversible.

Thus, it is believed that a salt-precipitation method of protein extraction results in protein properties different from proteins produced by AE-PPI, which results in thermo-reversible gels. It is believed that the salt-precipitation method results in a protein isolate which has a higher isoelectric point that that produced by alkaline extraction. In one embodiment, the salt-precipitated protein isolate has an isoelectric point of greater than 5.0, preferably greater than about 5.5, and more preferably about 5.9. Furthermore, it is believed that the protein isolate is enriched in aspartic acid and glutamic acid.

In addition, in some embodiments, higher amounts of glutamic acids and aspartic acids remain in the protein extract, which shifts the isoelectric point of the pulse protein isolate towards a higher pH. This higher isoelectric point is believed to induce the formation of thermo-reversible gels in an acidic condition.

The thermo-reversible gels may be formed with suitable protein concentrations at a desired pH. Generally, the higher the protein concentration, a lower pH is required to form a thermo-reversible gel. The protein concentration is preferably less than about 17% (w:v), and preferably between about 10 to about 15%. The pH level is preferably less than about 4.2, 4.0, 3.8 or 3.5, and preferably greater than about 2.4. In some embodiments, gels remain thermo-reversible in an acid environment within a window from pH 2.4-4.2 for 10% protein gel, from pH 2.4-3.8 for 13% protein gel and from pH 2.4-3.2 for 15% protein gel.

Thermo-reversible gels may be formed with a salt concentration less than about 2%, within the protein and pH ranges described above. Gels prepared with 0.1%-1% NaCl addition remain thermo-reversible at 4° and 80° C., suggesting that the reversible physical interactions still dominated in the gel structure at or below 1% salt level.

Thermo-reversible gels may be formed with an oil content of less than about 70% (v:v), preferably below about 60%, within the protein concentration, pH and salt content ranges described above. Gels formed with an oil content of between 20% and about 60% were demonstrated to remain thermo-reversible. In some embodiments, the oil is a plant-based oil or vegetable oil such as canola oil, soybean oil, sunflower oil, olive oil, palm oil or coconut oil. Where the gel is intended to be used in a food product that is free of animal products, it is preferred to use a plant-based oil such as canola oil.

### EXAMPLES

The following examples are intended to illustrate specific embodiments of the invention described herein, and not be limiting of the claimed invention in any way. The effects of pH, protein and salt concentration on the thermo-reversibility of the pea protein gels were systematically investigated and presented in the examples below. The appearance and microstructure of the gels were characterized, as well as their mechanical properties and water holding capacity. The mechanism of gel thermo-reversibility may be at least partly understood to be related to the protein conformational changes and interactions during the gelling process.

### Materials and Chemicals

Pea protein flour (PPF 55% protein) were provided by AGT Foods and Ingredients (Saskatchewan, Canada). Reagents and chemicals used in the experiments were purchased from Sigma-Aldrich (MO, USA) and Fisher Scientific (Ontario, Canada). Water used in this study was Milli-Q water purified by Milli-Q Advantage A10 system (EMD Millipore Corporation, MA, USA).

### Extraction of Pea Protein Isolate (PPI)

Pea protein isolate (PPI) was extracted using a known method with modifications (Bacon et al., 1990a). Pea protein flour was dispersed in 0.5 M sodium chloride (NaCl) aqueous solution at the solid to solvent ratio of 1:10 to make a suspension. Sodium hydroxide (NaOH, 2 mol/L) aqueous solution was added until pH 8.2 to further solubilize pea protein, followed by one hour of stirring at room temperature (22° C.). Afterwards, the suspension was centrifuged at 8000 rpm for 30 min using high performance centrifuge (Acanti® J-E centrifuge, Beckman Coulter, USA) to obtain the supernatant, followed by slowly adding ammonium sulfate ((NH₄)₂SO₄) to 65% saturation at room temperature and adjusted to pH 7.7 using 2 mol/L HCl solution. The suspension was centrifuged with the same condition as above to obtain the supernatant. Ammonium sulfate was further added to the supernatant to 95% saturation and centrifuged for 30 min at 8000 rpm to obtain the insoluble pellet. The protein pellet was dialyzed using regenerated cellulose tubing (Spectra/Por®3, 54 mm flat width, molecular weight cut-off: 3.5 kDa, Spectrum Chemical Mfg. Corp., Gardena, USA) against 50 mM ammonium acetate at 4° C. for 96 h. The dialyzed pea protein solution was freeze dried (Labconco Freezone 6 L Console Freeze Dryer System with Stoppering Tray Dryer) for 7 days to obtain the pea protein isolate (PPI).

The PPI protein content was 95.36±0.27% as determined by Leco nitrogen analyzer (Leco, USA) using nitrogen-protein conversion factor of 5.96 according to Fujihara, Kasuga, & Aoyagi (2001). The pea protein isolate extracted from ammonium sulfate precipitation method is referred to herein as “ASE-PPI”. Pea protein isolate extracted by conventional alkaline extraction and isoelectric point precipitation method was used for comparison during the protein characterization and is referred to as “AE-PPI”.

### Preparation of Thermo-Reversible Pea Protein Gels

PPI was added in distilled water to make pea protein solution, followed by stirring for 1 hour. PPI solution was adjusted to an acidic pH with the addition of citric acid at room temperature while stirring for 10 min for better solubilization. Afterwards, the PPI solution was heated at 80° C. for 10 min and the heated samples were cooled to room temperature and held at 4° C. for gel formation before analysis. Effects of protein concentration (10%-17% w:v), pH value (pH 2.4-pH 4.4), and salt concentration (0.1%-2% w:v) on pea protein gel properties were investigated.

### Effects of pH, Protein and Salt Concentration on Gel Thermo-Reversibility

Gels formed at different pH and protein concentration being thermo-reversible or not are shown in FIG. 3a. pH values which allowed thermo-reversible gel formation were identified for gels of each protein concentration, which were pH 4.2, 3.8 and 3.2 for gels formed at 10%, 13% and 15% protein concentration, respectively. When protein concentration was 17% or above, no thermo-reversible gelation was observed. It can be noticed that the gelling pH shifted to a lower value with increasing protein concentration, which was probably due to the fact that higher surface charge was required to prevent the formation of irreversible bonds between protein molecules, thus thermo-reversible gels at higher protein concentration were obtained at a lower pH. It may be possible to create thermo-reversible gel formation at 17% protein concentration, at a value about or below pH 2.4, however, the solution may be too viscous to solubilize further added citric acid. Reference to a “critical pH” in this disclosure is not intended to mean that that specific pH is essential to thermo-reversible gel formation. Thermo-reversible gel formation may occur below such a pH, and possibly above such a pH in some conditions.

Protein molecules are positively charged below their isoelectric point to induce electrostatic interactions, which are sensitive to ionic strength as the charges can be screened by counter ions through the addition of electrolytes, leading to the neutralization of electrostatic repulsion and increase of protein intermolecular interactions (Bryant & McClements, 1998). Since in food formulation, the addition of salt is commonly seen, the effects of salt concentration on gel appearance and thermo-reversibility were also investigated. Salt effect of 0.1%, 1% and 2% was studied on 10% gel at fixed pH value of pH 3.4. It was observed that the gels prepared with 0.1%-1% NaCl addition were thermo-reversible at 4-80° C., suggesting that the reversible physical interactions still dominated in the gel structure below 1% salt level. However, when salt concentration increased to 2%, the formed gel became thermo-irreversible, possibly due to the fully screened surface charges by excess addition of electrolytes, resulting in the formation of irreversible bonds between protein molecules.

To summarize, in some examples, ASE-PPI gels demonstrated thermo-reversibility at acid environment within a window from pH 2.4-4.2 for 10% protein gel, from pH 2.4-3.8 for 13% protein gel and from pH 2.4-3.2 for 15% protein gel. This allows possible applications in products with acidic pH. For condiments like mayonnaise, mustard, salad dressings and sauces, an acidic pH value between 3.3 and 4.0 is required to ensure food safety as foodborne pathogens such as Escherichia coli O157:H7 and Staphylococcus aureus, which have a minimum pH value that allows growth at pH 4.0 whereas the sensory properties can be compromised when pH goes below 3.2 (Smittle, 2000). For most fruits, beverage and fermented food, they have acidic pH range from 2 to 5, so a transparent acidic gel with thermo-reversibility should have great potential as gelling agent in various food formulations where acidic pH is essential, for example in yogurt, gelling agent like gelatin, pectin and starch are used as stabilizers.

### Gel Rheological Properties

Thermo-reversible gelation behavior of 10% ASE-PPI suspension at pH 3.4 was monitored on a DHR-3 rheometer (TA Instruments, DE, USA). Approximately 1.5 mL of protein suspension prepared at pH 3.4 with 10% protein concentration was loaded on 40 mm parallel plate geometry with a gap of 1 mm. Storage modulus (G′) and loss modulus G″ were measured during the temperature ramp, which was set at a rate of 5° C./min from 25° C. to 80° C. and held for 10 min, followed by cooling from 80° C. to 4° C. at a rate of 5° C./min for the first heating and cooling process. After cooling at 4° C. for 30 min, a second heating and cooling cycle was performed at the same condition. The angular frequency (ω) was set to be 1 Hz and the value of the strain amplitude was set as 1%. Frequency sweep measurements (0.1 to 100 rad/s) were performed at 4° C. on gel samples which had been heated and cooled for once, five and ten times to study how gel strength changed as a function of repeated heating and cooling treatments.

Transparent pea protein gel was formed with 10% protein concentration at pH 3.4 and was found to be thermo-reversible through 10 cycles of heating and cooling process (FIG. 2a). Repeated heating and cooling did not change the ability of pea protein to become liquid upon heating at 80° C. and solidified when cooled down at 4° C., showing that the thermo-reversibility of pea protein gels prepared from ASE-PPI was consistent and the gels also showed stability in terms of the appearance.

The rheological properties of ASE-PPI suspension and gel (10 wt %) with multiple heating and cooling cycles are shown in FIGS. 2b and 2c. Within two cycles of heating and cooling, the time-temperature rheological profile of ASE-PPI sol-gel transition is displayed in FIG. 2b. As the temperature increased during the initial heating process from 25° C. to 80° C., the storage modulus (G′) remained unchanged. Afterwards, during the holding period of heating temperature at 80° C., G′ value decreased at first and then climbed back to the original value before cooling. This result indicates that the heating process had limited impact on establishing the gel network. In contrast, the protein solution gelled during cooling as a rapid increase in both G′ and G″ was observed when temperature was decreased from 80° C. to 4° C. The gel G′ and G″ values was unaffected by the extended cooling held at 4° C., indicating that the gel network was mainly formed through cooling process. From above observations, reversible physical interactions were responsible for the gel network formation, especially hydrogen bonds might play a key role as hydrogen bonds occur and dominate at low temperature as they are exothermic while being destabilized at high temperature (Damodaran, 2008). During the re-heating stage, instant drop of G′ value was observed, and the formed gel transformed back to liquid state, suggesting that the gel network built through hydrogen bonds was disrupted, leading to a significant decrease in viscoelasticity. Afterwards, G′ value increased during the heating held at 80° C., which showed the consistency to that of the first heating stage, indicating that the gel network structure was first disrupted through heating while further heating will strengthen the viscoelasticity of the protein suspension. The increase of G′ continued as the re-cooling phase took place, where the protein suspension turned into solid gel state again, proving the thermo-reversible gelling capacity of this ammonium sulfate extracted pea protein suspension at acidic pH. Higher G′ value was observed for the gel formed during re-cooling compared to the gel formed from first cooling phase was probably due to the loss of water during the re-heating process which led to the increase of protein concentration. It is noticeable that the G′ value was higher than G″ at the very beginning before the heating process, which indicates that elastic behavior prevailed compared to the viscous behavior in the ASE-PPI suspension at acidic pH without heat treatment performed.

Storage modulus (G′) of ASE-PPI gels heated and cooled for once, five and ten times, respectively as function of frequency was shown in FIG. 2c. Frequency dependent rheology provides information about interaction types involved in the gel network formation (Almdal, Dyre, Hvidt, & Kramer, 1993). No significant change was observed in terms of the difference in gel strength as reflected by G′ value being almost the same, which indicates that the gel network structure did not change during repeated heating and cooling cycles, giving consistent pattern of gel melting and reformation. The gel strength also showed moderate frequency dependency, indicating that the gel was different in comparison to covalently crosslinked gels with low frequency dependency (Clark & Ross-Murphy, 1987).

### Turbidity and Transparency

Turbidity of pea protein suspension before heating and of the formed gels prepared at different conditions was measured using a 1-cm quartz cuvette assessed in the spectrophotometer (Spectramax® M3 (Molecular Devices LLC, Sunnyvale, CA), and the absorbance was measured at 600 nm. A cuvette filled with 1 mL of deionized water and an empty cuvette were used as reference for protein suspension and protein gel analysis, respectively.

Transparent gels may be formed at a pH of about 4.0 and lower. Effect of pH value on the appearance of ASE-PPI solution (before heating) and gel (after heating) at 10% protein concentration is shown in FIG. 1. Absorbance at a wavelength of 600 nm was measured at pH 2.8 to pH 4.2 to evaluate the turbidity difference. The pH range was selected based on the observation that no significant change in the absorbance of protein solutions was noted when going below pH 2.8 or over pH 4.2. Samples with absorbance under 1.5 may be considered as transparent or translucent whereas those over 1.5 regarded as opaque (Kinekawa & Kitabatake, 1995).

According to FIG. 1a, the absorbance of unheated protein solution at 600 nm increased gradually as the pH value grew from pH 2.8 to pH 4.2, showing that the solution became more turbid as the pH increased. Similar pattern was observed for the absorbance of protein gels, except for that the gels showed lower absorbance when compared to protein solution, indicating that the transparency was improved during the transition from solution to gel upon heating and cooling treatment.

Gel transparency is affected as a function of pH and the gel turbidity increased as the pH value went close to the isoelectric point of ASE-PPI (pH 5.9) due to reduced electrostatic repulsion force that promoted random protein aggregation and formation of particulate aggregates, giving opacity of the gels. When pH value went far away from pI, the charge on protein molecular chains increased, enabling ordered aggregation and more transparent gels (Howell, 1992). For both protein solution and gel, pH 3.4 is a point above which increase of turbidity was observed. The gels formed at pH 3.4 possessed integrated structure, at the same time being transparent, which is an advantage for a gel to be applied in both food and non-food areas, while the gels became weaker when formed at lower pH and turned opaque at higher pH (FIG. 1b).

### Effects of pH, and Protein and Salt Concentration on Gel Appearance, Microstructure and Mechanical Properties

Gels prepared at different pHs and protein concentrations were observed for their morphology. The gel samples were frozen in liquid nitrogen, and then freeze-dried overnight. Cross-sectional view of the freeze-dried pea protein gels were sputter-coated with gold and the morphology was observed using a Philips XL-30 scanning electron microscope (SEM) at an acceleration voltage of 20 kV. In SEM images, the average diameter of the pores was measured and analyzed based on 100 randomly selected pores (20 for each image×5) for each sample using Image J software developed by the National Institutes of Health.

Gel samples with about 10 mm in length and 13 mm in diameter were analyzed by a universal testing machine (Instron® 5967, Instron Corp., MA, USA) with a 50 N load cell to obtain the relation between compressive strain and stress. Repeated compression test was also performed by compressing the samples twice to 40% strain at room temperature with the crosshead speed of 1 mm/min. Textural parameters including hardness, springiness, and cohesiveness were computed based on the data analysis by software (Blue Hill 2).

FIG. 3b shows the images of gels formed at gelling pHs, giving that 13% and 15% protein gels were transparent while 10% protein gel was opaque. This result was consistent to the result of gel turbidity in FIG. 3g, where opaque gels were obtained at 10% protein with an absorbance of around 3.0 at 600 nm, while those of 13% and 15% protein gels were transparent with turbidity below 0.2. It was also noticed that the absorbance of gels formed at pH 3.4 with 10%, 13%, 15% and 17% protein concentration were all below 0.1, giving transparent gels, however, at fixed pH 3.4, the gels prepared with 15% and 17% protein were not thermo-reversible, whereas those prepared with 10% and 13% protein were thermo-reversible. As shown in FIGS. 3e and 3h, at relatively low salt concentration of 0.1%, the formed gel was transparent without much change of absorbance at 600 nm. As salt concentration increased to 1%, gel turbidity increased due to the aggregation of fine strands resulting from reduced electrostatic repulsion (Barbut & Foegeding, 1993). The results indicate that being transparency was not a necessary condition for the ASE-PPI gel to be thermo-reversible.

Scanning electron microscopic (SEM) images of ASE-PPI gels prepared at different pH and protein concentration are displayed in FIG. 3i. Fine-stranded network structure with thin connective walls was observed both in 10% and 13% protein gel prepared at pH 3.4, giving polymer-like microstructure with pore sizes of 5.61±0.79 μm and 3.27±0.35 μm evenly distributed, respectively. Such morphology should explain the transparency of the gel as more light can be transmitted without scattering in homogenous fine-stranded network (Maltais, Remondetto, Gonzalez, & Subirade, 2005). Similar percolating network structure with thin connective walls was observed in 2.5% pure gelatin gels except that the pores were of various size with spherical shape according to Treesuppharat, Rojanapanthu, Siangsanoh, Manuspiya, & Ummartyotin (2017). In contrast, for 10% gel prepared at pH 4.2, which was closer to its pI, particulate aggregates were observed in the network structure with fewer pores, and they were distributed unevenly, where large aggregates were able to scatter more light, giving higher opacity to the gel (FIG. 1b). The result indicates that pH value affected the gel transparency through alteration of gel microstructure while the fine-stranded structure did not ensure gel thermo-reversibility.

As shown in FIG. 3c, it is noticeable that the 13% gels prepared at pH 3.8 displayed satisfactory mechanical properties with compressive strength of 6.32±1.40 kPa and compressive strain of 51.0±1.7%, which also showed good thermo-reversibility, being transparent at the same time. This gel has a comparable strength to thermally induced pea protein gel prepared with 20% pea protein (Makri, Papalamprou, & Doxastakis, 2006) and 5% gelatin gel (Forte, D'Amico, Charalambides, Dini, & Williams, 2015).

In addition, the gels prepared at pH 3.4 were evaluated for their mechanical properties as a function of protein concentration. With the increase of protein concentration, the compressive strength of formed gels increased whereas the compressive strain decreased, indicating that the gel formed at higher protein concentration gave better gel strength yet was less elastic. Gels prepared with 17% protein demonstrated the highest compressive strength of 20.38±2.57 kPa, however, the gel lost their thermo-reversibility when protein concentration was 17% or above.

The gels prepared at pH 3.4 and 10% protein were evaluated for their mechanical properties as a function of salt concentration. Gels with higher salt concentration exhibited higher compressive strength while also much lower compressive strain (FIG. 3d). Increasing protein and salt concentration led to stronger but less elastic gels as more intermolecular interactions were enabled at high protein concentration and neutralized surface charge to make the gel stronger, but at the same time reduced the protein mobility, leading to reduced elasticity.

### Effects of pH, Salt and Protein Concentration on Gel Water Holding Capacity

Water holding capacity (WHC) of the gel was determined through the method from Kocher and Foegeding (1993) with modifications. Approximately 1.0 gram of the gel sample was loaded in ultrafiltration tube from Vivaspin Turbo 15, 3,000 MWCO (Sartorius Stedlm Lab Ltd., Stonehouse, UK) and centrifuged at 4000 rpm for 10 min at room temperature. The isolated water was discarded and the weights of the tube together with the sample gel before and after centrifugation were recorded as [symbol] and [symbol] . The weight of ultrafiltration tube was recorded as [symbol] . WHC was calculated as equation (1):

$$W H C \% = \frac{W 2 - W}{W 1 - W} \times 100 \% \qquad ( 1 )$$

0.1 M Acetate buffer at pH 5.5 and 0.1 M phosphate buffer at pH 7.4 were prepared for the swelling test of the gels. Approximately 1.0 gram of gel samples were soaked into 60 mL of each buffer for up to 32 h at room temperature.

FIG. 3f displayed the water holding capacity (WHC) of the gels as functions of salt and protein concentration along with gels formed at critical points. With the increase of protein concentration, the WHC of formed gels at fixed pH value (pH 3.4) increased, with all of them exceeding 90% and were considered as control samples for the comparison of gels prepared at different pH value and salt concentration. The improvement in WHC was consistent to the result of gel microstructure, where more sophisticated fine-stranded network structure with smaller evenly distributed pores was able to trap more water inside the structure as suggested by Munialo, van der Linden, & de Jongh. (2014). As for the effect of salt concentration on gel WHC, a significant increase in WHC to over 95% was observed in gels with 0.1% and 1% salt addition, which could attribute to the salting-in effect in improving the solubility of protein, and the increase in protein solubility is known to promote protein-water interaction, thus contributing to increased WHC (Xiong & Brekke, 1989).

On the other hand, with 2% NaCl addition, gel WHC was significantly decreased to 89.14±0.29% with noticeable syneresis observed. As negative charges are completely neutralized at high ionic strength, extensive protein aggregations are induced while protein-water interactions decrease (Maltais et al., 2005). Moreover, extensive protein aggregates lead to particulate structure of gel with large and unevenly pore sizes, which tends to have low WHC as water can be easily expelled through this open structure (Hongsprabhas & Barbut, 1997). It is noticeable that three gels formed at the critical points had relatively low WHC compared to gels prepared at pH 3.4 because 10% and 13% gels prepared at critical point had pH values closer to protein isoelectric point at pH 4.2 and 3.8, respectively, leading to particulate gel structure with lower WHC. However, for 15% gel prepared at critical point at pH 3.2, stronger electrostatic repulsions were induced at lower pH value to prevent the formation protein intermolecular interactions so that very loose gel network structure might be established, leading to low WHC (Kleemann et al., 2020).

### Characterizations of ASE-PPI and AE-PPI

The protein profiles of ASE-PPI and AE-PPI were analyzed by SDS-PAGE (sodium dodecyl sulphate-polyacrylamide gel electrophoresis).

Zeta potential and particle size of ASE-PPI as a function of pH was measured using a Zetasizer Nano-ZS ZEN1600 (Malven Instruments, UK) at 25° C. Stock protein solution with 0.2% protein concentration was prepared with stirring of 1 h. Protein samples were diluted ten-fold to 0.02% and adjusted to various pH values. After that, the protein samples were measured, and the data were obtained by SoftMax Pro 7.1 with the average of triplicates.

One dimensional SDS-PAGE was performed to study the protein profile of ASE-PPI by determining the molecular weight of protein subunits. SDS-PAGE was performed according to Laemmli (1970), where protein samples (2.5 mg/mL) were mixed with sample buffer (0.125 M Tris-HCl pH 6.8, 4% w/v SDS, 20% v/v glycerol, and 1% bromophenol blue w/v, 0.5% 2-mercaptoethanol was added for reducing condition) and heated at 100° C. for 5 min. After cooling to room temperature, the samples were centrifuged at 4000 rpm for 5 min and loaded with 10 μL per lane on 4% stacking gel and 12% separating gel. A standard marker Precision Plus Protein™ Standard #161-0374 (Bio-Rad Lab., Hercules, CA, USA) was loaded on a separate lane. A constant voltage of 80 V was applied. After electrophoresis, the gel was stained with 0.1% (w/v) Coomassie Brilliant Blue R-250 for 20 min and de-stained with water, methanol, and acetic acid at a ratio of 4:5:1 (v/v/v) overnight.

Reduction of disulfide bonds was applied as reduced condition as displayed in FIG. 4b. Protein profiles of ASE-PPI and AE-PPI were overall similar except for that one band at 90 kDa, which referred to lipoxygenase, was observed in AE-PPI while not shown in ASE-PPI, indicating that the ammonium sulfate extraction method of protein used in this study might be able to remove lipoxygenase. Both protein profiles with non-reduced condition showed bands at 50 and 60 kDa, which corresponded to vicilin monomer (7S) and legumin monomer (11S), respectively. It is noticeable that bands at 60 kDa disappeared and two bands at 40 kDa and 20 kDa appeared in the reduced condition of protein, which can be related to acidic (40 kDa) and basic (20 kDa) subunits of legumin monomer, indicating that disulfide bonds connecting acidic and basic subunits were disrupted under reducing condition (Matta, Gatehouse, & Boulter, 1981; Shand, Ya, Pietrasik, & Wanasundara, 2007). Bands at 70 kDa, 35 kDa, 33 kDa and those under 20 kDa appeared in both reduced and non-reduced conditions, where 70 kDa protein has been matched with convicilin (O'Kane et al., 2004a). Since there are no disulfide bonds involved in vicilin protein, and vicilin has been reported to have three fractions including α, β, γ, having molecular weight of 19 kDa, 13.5 kDa, and 16 or 12.5 kDa, respectively, so the unchanged bands at 35 kDa, 33 kDa and under 20 kDa can be related to major and minor subunits of vicilin fractions arranged differently according to Gatehouse, Lycett, Croy, & Boulter (1982).

### Amino Acid Composition

Samples were acid hydrolyzed according to Simpson, Neuberger, & Liu (1976). Amino acid analysis of protein was determined by a HPLC system (Agilent series 1100, Palo Alto, CA) consisted of an autosampler and a binary pump, a control system with a column heater maintained at 37° C., and a UV detector set at a wavelength of 254 nm. A reversed-phase C18 column (150×3.9 mm) was used at a flow rate of 1.5 mL/min. Data acquisition was controlled by ChemStation software. Tryptophan was not measured.

Amino acid profiles of ASE-PPI and AE-PPI are shown in Table 1. It is noticeable that acidic amino acids including aspartic acid and glutamic acid in ASE-PPI were significantly higher than those in AE-PPI, which has explained the shift of isoelectric point of ASE-PPI to higher pH value (pH 5.9) compared to that of AE-PPI (pH 4.4) as shown in FIG. 4a. Since the pI values of aspartic acid and glutamic acid are 2.77 and 3.22, respectively, which indicated that more of those acidic amino acids remained negatively charged during ASE-PPI gel formation at pH 3.4, contributing to electrostatic repulsions to facilitate the fine-stranded gel network structure. It can also be noted that no methionine or cysteine was detected in ASE-PPI while little could be found in AE-PPI, indicating that very limited amount of legumin present in the ammonium sulfated extracted pea protein. Thus it appears that a high proportion of vicilin and convicilin (7S protein) is preferred in salt extraction of pea protein (Yang, Zamani, Liang, & Chen (2021)). High proportion of vicilin and convicilin protein can also explain for formation of the thermo-reversibility gels at 80° C. as the denaturation temperature of vicilin protein grew from 70° C. to 84° C. with increase of the ionic strength. On the other hand, legumin (11S) is a protein connected with disulfide bonds and has a thermal denaturation temperature of over 83° C. depending on ionic strength (O'Kane et al., 2004b), which again indicates that there should be much less legumin and the major proteins involved in gel formation could be vicilin and convicilin.

TABLE 1
Amino acid profiles of ASE-PPI and AE-PPI.

| Amino acid | ASE-PPI (%) | AE-PPI (%) |
|---|---|---|
| Asx | 10.70 | 8.98 |
| Ser | 5.97 | 6.36 |
| Glx | 15.49 | 9.45 |
| Gly | 5.28 | 6.05 |
| His | 1.96 | 2.32 |
| Arg | 6.40 | 6.54 |
| Thr | 3.21 | 4.31 |
| Ala | 4.54 | 5.20 |
| Pro | 4.04 | 4.04 |
| Cys | 0.00 | 0.89 |
| Tyr | 2.21 | 2.79 |
| Val | 4.45 | 5.63 |
| Met | 0.00 | 0.93 |
| Lys | 8.87 | 10.03 |
| Ile | 4.26 | 4.94 |
| Leu | 7.98 | 8.13 |
| Phe | 3.99 | 4.21 |

### Protein Conformational Change

The conformational change of pea protein during the gel preparation was analyzed by FTIR (Fourier Transform Infrared Spectroscopy). Pea protein isolate was dissolved in D₂O with a protein concentration of 5% (wt %). The pD of protein solution was adjusted using 0.1% DCl. The wet samples were placed between CaF₂ windows separated by a 25 mm polyethylene terephthalate film spacer for FT-IR analysis by Nicolet 6700 spectrophotometer (Thermal Fisher Scientific Inc., Pittsburgh, PA, USA) at the wavenumber from 400 to 4000 cm⁻¹ with 128 scans at a 4 cm⁻¹ resolution. D₂O was used as background. Fourier self-deconvolution for amide I region (1700-1600 cm⁻¹) was performed using Omnic 8.1 software at a bandwidth of 24 cm⁻¹ and an enhancement factor of 2.5 (Lefèvre & Subirade, 1999).

Protein conformational change related to unfolding and aggregation during the gel formation was measured by FTIR spectra showing in FIG. 5a, where the band of amide I region is depicted. Assignments of the secondary structure for protein were based on the research from Byler and Susi (1986) as 1619 cm⁻¹ and 1631 cm⁻¹ (β-sheets), 1642 cm⁻¹ (random coil), 1651 cm⁻¹ and 1659 cm⁻¹ (α-helix), 1682 cm⁻¹ and 1691 cm⁻¹ (β-turns). The absorption intensity of spectra for native protein was very limited probably due to the minimum solubility of native protein in solution because the native protein solution had a pH value of pH 6.1, which was very close to the isoelectric point of protein as discussed in FIG. 4a. By adjusting ASE-PPI solution (5 wt %) to pH 3.4 using citric acid, being different from the spectra from native protein (FIG. 5a-I), the disappearance of peak at 1651 cm⁻¹ indicates the interruption of the original α-helix structure upon the electrostatic repulsion (FIG. 5a-II). At the same time, the appearance of peaks at 1642 cm⁻¹ and 1659 cm⁻¹ (distorted α-helix) were observed in the spectra, showing the conversion of α-helix into random coil and the distortion of α-helix probably due to dynamic fluctuation of α-helical confirmation, which might change the pattern of hydrogen bonding formation (Manning, Illangasekare, & Woody, 1988), where intermolecular interactions through hydrogen bonds which were thermo-reversible might be promoted. An increase in the formation of random coils was also observed in porcine plasma protein interpreted as protein partial unfolding when the pH decreased (Gatehouse, Croy, Morton, Tyler, & Boulter, 1981; Gueguen & Cerletti, 1994). Upon heating and cooling process, the spectra of protein (FIG. 5a-III) changed, where the peak at 1691 cm⁻¹ disappeared and new absorption intensity at 1619 cm⁻¹ and 1682 cm⁻¹ appeared, indicating that protein aggregation was induced through hydrogen bonds to form intermolecular β-sheets during the formation of gels. B-sheet structure has also been found to play important role in both the formation of fibril and subsequent gelation of thermo-reversible gels (Lefèvre & Subirade, 2000; Yan et al., 2008). In addition, direction of polypeptides was changed through the disappearance of β-turns at 1691 cm⁻¹ and the appearance of it at 1682 cm⁻¹, where the interchange of β-turns might be of critical importance to the gel formation as well as its thermo-reversibility.

### Molecular Interactions in Pea Protein Gels

Gels of approximately 10 mm in length and 13 mm in diameter were soaked into water (controls), 6M urea, 0.06M 2-mercaptoethanol (2-ME), and 3 wt % sodium dodecyl sulfate (SDS) solution as dissociation reagents for 2 h to disrupt hydrogen bonds, disulfide bonds, and hydrophobic interactions, respectively, to understand the molecular interactions involved in the formed gel. Frequency sweep analysis were performed on the soaked gel samples over a range of 0.1-100 rad/s at 25° C. with 1% strain. Storage modulus (G′) in response to frequency were plotted.

Gel dissociation test was performed to understand the involved interactions in the formed gel. Gels were soaked in SDS, urea, and 2-ME dissociation reagents to disrupt hydrophobic interactions, hydrogen and disulfide bonds, respectively. A frequency sweep test was followed to test the gel rheological properties treated with those dissociation reagents and shown in FIG. 5b. It is noticeable that the gel melted and disappeared in 0.6 M urea solution within 2 h and in deionized water within 24 h, supporting that predominantly hydrogen bonds were involved in the formation and stabilization the gel network structure. Disulfide bonds show slightly better contribution to the gel formation compared to hydrophobic interactions reflected as a lower G′ value shown in FIG. 5b, however, both were of minor importance. The disulfide bonds should be resulted from those connecting the acidic and basic subunits of legumin, which was not disrupted during the heating process to form gel and remained unchanged during the re-heating and re-cooling procedure. The result suggests that vicilin and convicilin protein were the major components involved in the gel formation as a highly charged (60%) and hydrophilic (92%) N-terminal extension region of 122 residues has been reported to present in convicilin protein compared to vicilin (O'Kane et al., 2004c), which should facilitate the formation of hydrogen bonds. As mentioned above, the isoelectric point has been shifted towards higher pH probably due to the extraction of acidic amino acids which has been revealed from its amino acid profile (Table 1). The higher isoelectric point was further away from pH 3.4, resulting in highly charged protein residues that gave strong repulsive forces, which prevented the formation of large aggregate while helped with the formation of fine-stranded network structure. Since disulfide bond was reported to be important for a gel network structure to remain its stability against rearrangement upon heating (O'Kane et al., 2004c), it should not play an important role in a gel that was thermo-reversible, which has also been proved through its amino acid profile, where no methionine or cysteine were identified in ASE-PPI while small amount of them were found in conventionally extracted pea protein (Table 1). In addition, hardly any hydrophobic interactions were identified in the dissociation test due to high electrostatic repulsions, the gel in this work was physically crosslinked with primarily hydrogen bonds.

### Impact of Oil on Thermal Reversibility

The impact of oil fraction on the thermo-reversibility of pea protein gels was also studied. The gels were prepared at 10% pea protein concentration at pH 3.4 with a canola oil fraction varying from 20-70% (v:v). As shown in FIG. 6, thermo-reversibility was maintained when the oil fractions were in the range of 20-60% as the gels melted at 80° C. and then re-formed at 4° C. and this process could be repeated many times. However, when the oil fractions were 70% or higher, the thermal reversibility disappeared. This result indicates that the pea protein can also form thermal-reversible emulsion gels with oil fraction up to 60%, thus permitting a wider range of food applications considering oil is a major component in many food formulations.”

### Statistical Analysis

All experiments were carried out in three independent batches and the results were reported as mean±standard deviations. Analysis of variance (ANOVA) was performed at 95% confidence level for statistical evaluation, followed by Tukey's test to compare multiple means. A probability of p<0.05 was considered to be statistically significant.

### REFERENCES

The following references are provided to indicate the relative level of skill in the art, and are incorporated into this disclosure by reference in their entirety, where permitted.
Almdal, K., Dyre, J., Hvidt, S., & Kramer, O. (1993). Towards a phenomenological definition of the term ‘gel.’ Polymer Gels and Networks, 1(1), 5-17. https://doi.org/https://doi.org/10.1016/0966-7822(93)90020-I
Bacon, J. R., Noel, T. R., & Lambert, N. (1990). Preparation of transparent protein gels from plant seeds. Food Hydrocolloids, 3(6), 491-495. https://doi.org/https://doi.org/10.1016/S0268-005X(09)80227-0
Bacon, J. R., Noel, T. R., & Lambert, N. (1990). Preparation of transparent pea protein gels: a comparison of isolation procedures. International Journal of Food Science & Technology, 25(5), 527-537. https://doi.org/https://doi.org/10.1111/j.1365-2621.1990.tb01112.x
Barac, M., Cabrilo, S., Pesic, M., Stanojevic, S., Zilic, S., Macej, O., & Ristic, N. (2010). Profile and Functional Properties of Seed Proteins from Six Pea (Pisum sativum) Genotypes. In International Journal of Molecular Sciences (Vol. 11, Issue 12). https://doi.org/10.3390/ijmsl 1124973
Barbut, S., & Foegeding, E. A. (1993). Ca2+-Induced Gelation of Pre-heated Whey Protein Isolate. Journal of Food Science, 58(4), 867-871. https://doi.org/https://doi.org/10.1111/j.1365-2621.1993.tb09379.x
Bown, D., Ellis, T. H. N., & Gatehouse, J. A. (1988). The sequence of a gene encoding convicilin from pea (Pisum sativum L.) shows that convicilin differs from vicilin by an insertion near the N-terminus. Biochemical Journal, 251(3), 717-726. https://doi.org/10.1042/bj2510717
Boye, J., Zare, F., & Pletch, A. (2010). Pulse proteins: Processing, characterization, functional properties and applications in food and feed. Food Research International, 43(2), 414-431. https://doi.org/https://doi.org/10.1016/j.foodres.2009.09.003
Brenner, T., Nicolai, T., & Johannsson, R. (2009). Rheology of thermo-reversible fish protein isolate gels. Food Research International, 42(8), 915-924. https://doi.org/https://doi.org/10.1016/j.foodres.2009.04.020
Bryant, C. M., & McClements, D. J. (1998). Molecular basis of protein functionality with special consideration of cold-set gels derived from heat-denatured whey. Trends in Food Science & Technology, 9(4), 143-151. https://doi.org/https://doi.org/10.1016/S0924-2244(98)00031-4
Byler, D. M., & Susi, H. (1986). Examination of the secondary structure of proteins by deconvolved FTIR spectra. Biopolymers, 25(3), 469-487. https://doi.org/https://doi.org/10.1002/bip.360250307
Clark, A. H., & Ross-Murphy, S. B. (1987). Structural and mechanical properties of biopolymer gels BT-Biopolymers. 57-192.
Damodaran, S. (2008). Amino acids, peptides and proteins (Vol. 4). CRC Press: Boca Raton, FL.
Forte, A. E., D'Amico, F., Charalambides, M. N., Dini, D., & Williams, J. G. (2015). Modelling and experimental characterisation of the rate dependent fracture properties of gelatine gels. Food Hydrocolloids, 46, 180-190. https://doi.org/https://doi.org/10.1016/j.foodhyd.2014.12.028
Fujihara, S., Kasuga, A., & Aoyagi, Y. (2001). Nitrogen-to-Protein Conversion Factors for Common Vegetables in Japan. Journal of Food Science, 66(3), 412-415. https://doi.org/https://doi.org/10.1111/j.1365-2621.2001.tb16119.x
Gatehouse, J. A., Croy, R. R. D., Morton, H., Tyler, M., & Boulter, D. (1981). Characterisation and Subunit Structures of the Vicilin Storage Proteins of Pea (Pisum sativum L.). European Journal of Biochemistry, 118(3), 627-633. https://doi.org/https://doi.org/10.1111/j.1432-1033.1981.tb05565.x
Gatehouse, J. A., Lycett, G. W., Croy, R. R. D., & Boulter, D. (1982). The post-translational proteolysis of the subunits of vicilin from pea (Pisum sativum L.). Biochemical Journal, 207(3), 629-632. https://doi.org/10.1042/bj2070629
Hongsprabhas, P., & Barbut, S. (1997). Protein and Salt Effects on Ca2+-Induced Cold Gelation of Whey Protein Isolate. Journal of Food Science, 62(2), 382-385. https://doi.org/https://doi.org/10.1111/j.1365-2621.1997.tb04006.x
Howell, N. K. (1992). Protein-Protein Interactions BT-Biochemistry of Food Proteins (B. J. F. Hudson, Ed.; pp. 35-74). Springer US. https://doi.org/10.1007/978-1-4684-9895-O_2
Kinekawa, Y., & Kitabatake, N. (1995). Turbidity and Rheological Properties of Gels and Sols Prepared by Heating Process Whey Protein. Bioscience, Biotechnology, and Biochemistry, 59(5), 834-840. https://doi.org/10.1271/bbb.59.834
Kleemann, C., Zink, J., Selmer, I., Smirnova, I., & Kulozik, U. (2020). Effect of Ethanol on the Textural Properties of Whey Protein and Egg White Protein Hydrogels during Water-Ethanol Solvent Exchange. In Molecules (Vol. 25, Issue 19). https://doi.org/10.3390/molecules25194417
Laemmli, U. K. (1970). Cleavage of Structural Proteins during the Assembly of the Head of Bacteriophage T4. Nature, 227(5259), 680-685. https://doi.org/10.1038/227680a0
Lefèvre, T., & Subirade, M. (1999). Structural and interaction properties of β-Lactoglobulin as studied by FTIR spectroscopy. International Journal of Food Science & Technology, 34(5-6), 419-428. https://doi.org/https://doi.org/10.1046/j.1365-2621.1999.00311.x
Lefèvre, T., & Subirade, M. (2000). Molecular differences in the formation and structure of fine-stranded and particulate β-lactoglobulin gels. Biopolymers, 54(7), 578-586. https://doi.org/https://doi.org/10.1002/1097-0282(200012)54:7<578: AID-BIP100>3.0.CO; 2-2
Makri, E. A., Papalamprou, E. M., & Doxastakis, G. I. (2006). Textural properties of legume protein isolate and polysaccharide gels. Journal of the Science of Food and Agriculture, 86(12), 1855-1862. https://doi.org/https://doi.org/10.1002/jsfa.2531
Maltais, A., Remondetto, G. E., Gonzalez, R., & Subirade, M. (2005). Formation of Soy Protein Isolate Cold-set Gels: Protein and Salt Effects. Journal of Food Science, 70(1), C67-C73. https://doi.org/https://doi.org/10.1111/j.1365-2621.2005.tb09023.x
Manning, M. C., Illangasekare, M., & W. Woody, R. (1988). Circular dichroism studies of distorted α-helices, twisted β-sheets, and β-turns. Biophysical Chemistry, 31(1), 77-86. https://doi.org/https://doi.org/10.1016/0301-4622(88)80011-5
Matta, N. K., Gatehouse, J. A., & Boulter, D. (1981). Molecular and Subunit Heterogeneity of Legumin of Pisum sativum L. (Garden Pea) A Multi-Dimensional Gel Electrophoretic Study. Journal of Experimental Botany, 32(6), 1295-1307. https://doi.org/10.1093/jxb/32.6.1295
Munialo, C. D., van der Linden, E., & de Jongh, H. H. J. (2014). The ability to store energy in pea protein gels is set by network dimensions smaller than 50 nm. Food Research International, 64, 482-491. https://doi.org/https://doi.org/10.1016/j.foodres.2014.07.038
O'Kane, F. E., Happe, R. P., Vereijken, J. M., Gruppen, H., & van Boekel, M. A. J. S. (2004c). Heat-Induced Gelation of Pea Legumin: Comparison with Soybean Glycinin. Journal of Agricultural and Food Chemistry, 52(16), 5071-5078. https://doi.org/10.1021/jf035215h
Shand, P. J., Ya, H., Pietrasik, Z., & Wanasundara, P. K. J. P. D. (2007). Physicochemical and textural properties of heat-induced pea protein isolate gels. Food Chemistry, 102(4), 1119-1130. https://doi.org/https://doi.org/10.1016/j.foodchem.2006.06.060
Simpson, R. J., Neuberger, M. R., & Liu, T. Y. (1976). Complete amino acid analysis of proteins from a single hydrolysate. Journal of Biological Chemistry, 251(7), 1936-1940. https://doi.org/https://doi.org/10.1016/S0021-9258(17)33637-2
Smittle, R. B. (2000). Microbiological Safety of Mayonnaise, Salad Dressings, and Sauces Produced in the United States: A Review. Journal of Food Protection, 63(8), 1144-1153. https://doi.org/10.4315/0362-028X-63.8.1144
Treesuppharat, W., Rojanapanthu, P., Siangsanoh, C., Manuspiya, H., & Ummartyotin, S. (2017). Synthesis and characterization of bacterial cellulose and gelatin-based hydrogel composites for drug-delivery systems. Biotechnology Reports, 15, 84-91. https://doi.org/https://doi.org/10.1016/j.btre.2017.07.002
Xiong, Y. L., & Brekke, C. J. (1989). Changes in Protein Solubility and Gelation Properties of Chicken Myofibrils during Storage. Journal of Food Science, 54(5), 1141-1146. https://doi.org/https://doi.org/10.1111/j.1365-2621.1989.tb05941.x
Yang, J., Zamani, S., Liang, L., & Chen, L. (2021). Extraction methods significantly impact pea protein composition, structure and gelling properties. Food Hydrocolloids, 117, 106678. https://doi.org/https://doi.org/10.1016/i.foodhyd.2021.106678
Zhang, D., Mu, T., Sun, H., Chen, J., & Zhang, M. (2017). Comparative study of potato protein concentrates extracted using ammonium sulfate and isoelectric precipitation. International Journal of Food Properties, 20(9), 2113-2127.”
Zhu, P., Huang, W., Guo, X., & Chen, L. (2021). Strong and elastic pea protein hydrogels formed through pH-shifting method. Food Hydrocolloids, 117, 106705. https://doi.org/https://doi.org/10.1016/j.foodhyd.2021.106705

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated. To the extent that the following description is of a specific embodiment or a particular use of the invention, it is intended to be illustrative only, and not limiting of the claimed invention.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to combine, affect or connect such aspect, feature, structure, or characteristic with other embodiments, whether or not such connection or combination is explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited, and such terms refer to ranges that can be subsequently broken down into sub-ranges as discussed above. In the same manner, all ratios recited herein also include all sub-ratios falling within the broader ratio.

1. A thermo-reversible protein gel comprising proteins which comprise or consist essentially of:
a. pulse plant proteins extracted by a salted in-salted out precipitation method;
b. vicilin and/or convicilin; or
c. a pulse plant protein isolate having an isoelectric point of greater than 5.0, preferably greater than about 5.5, and more preferably about 5.9.

2. The gel of claim 1 wherein the pulse plant is pea.

3. The gel of claim 1, wherein the precipitation method is an ammonium sulfate precipitation method.

4. The gel of claim 1, wherein the gel is thermo-reversible at temperatures between about 4° C. and about 80° C.

5. The gel of claim 1 which is thermo-reversible in a pH range of between about 2.4 to about 4.2, with a protein concentration between about 10% (w:v) to about 15%.

6. The gel of claim 5 wherein the gel is thermo-reversible in a pH range of:
a. from pH 2.4 to 4.2 for a 10% (w:v) protein gel,
b. from pH 2.4 to 3.8 for 13% (w:v) protein gel; or
c. from pH 2.4 to 3.2 for 15% (w:v) protein gel.

7. The gel of claim 1 having a salt concentration of less than about 2%, or in the range of 0.1% to about 1.0%.

8. The gel of claim 1 further comprising an oil in less than about 70% (v:v), or between about 20% and about 60%, wherein the oil is preferably a vegetable oil such as canola oil.

9. A method of forming a thermo-reversible gel comprising:
a. pulse plant proteins extracted by a salted in-salted out precipitation method;
b. vicilin and/or convicilin; or
c. a pulse plant protein isolate having an isoelectric point of greater than 5.0, preferably greater than about 5.5, and more preferably about 5.9;
forming an aqueous gelling composition of the proteins having a protein concentration greater than about 5% (w:v) and less than about 17% (w:v), at a pH of greater than about 2.4 and less than about 4.2.

10. The method of claim 9 wherein the precipitation method is an ammonium sulfate precipitation method.

11. The method of claim 9, wherein the pH is in the range of pH 2.4 to 4.2 for a 10% (w:v) protein gel; from pH 2.4 to 3.8 for 13% (w:v) protein gel; or from pH 2.4 to 3.2 for 15% (w:v) protein gel.

12. The method of claim 9 wherein the aqueous solution has a salt concentration of less than about 2%, or in the range of 0.1% to about 1.0%.

13. The method of claim 9 wherein gelling composition comprises an oil in less than about 70% (v:v), or between about 20% and about 60%, wherein the oil is preferably a vegetable oil such as canola oil.

14. The method of claim 9 wherein the pulse plant is pea.

15. A food or beverage comprising a thermo-reversible gel as claimed in claim 1.
